(19) United States
(12) Patent Application Publication
(10) Pub. No.: US 2017/0160415 A1
(43) Pub. Date: Jun. 8, 2017

(54) SYSTEMATIC DEPARTURE FROM PATTERN REGULARITY IN SEISMIC DATA ACQUISITION

(71) Applicant: CGG SERVICES SAS, Massy Cedex (FR)

(72) Inventors: Richard WINNETT, Faversham (GB); Robert MONTGOMERY, Katy, TX (US); Gordon POOLE, East Grinstead (GB); Jonas ROHNKE, Crawley (GB); Julie SVAY, Guyancourt (FR); John SALLAS, Plano, TX (US)

(21) Appl. No.: 15/325,565

(22) PCT Filed: Jul. 16, 2015
(86) PCT No.: PCT/IB2015/001304

§ 371 Date: Jan. 11, 2017

Related U.S. Application Data
(60) Provisional application No. 62/025,511, filed on Jul. 17, 2014.
(60) Provisional application No. 62/068,780, filed on Oct. 27, 2014.

(51) Int. Cl. G01V 1/38; G01V 1/20

(52) U.S. Cl. CPC G01V 1/3808; G01V 1/20

(57) ABSTRACT

During seismic data acquisition the seismic sources and/or seismic receivers are deployed according to an irregular arrangement departing in a predetermined manner from repetitive spatial patterns formed by or within groups of adjacent among the seismic sources or adjacent among the receivers. Additionally or alternatively, source activation moments of the sources within a series of source firing time intervals are determined using Golomb ruler sequences or a non-linear inversion.

### CROSS REFERENCE TO RELATED APPLICATIONS

This application claims priority and benefit from U.S. Provisional Patent Application No. 62/025,511, filed on Jul. 17, 2014, for “Means and method for acquiring marine seismic data using non-uniform spatial sampling,” and U.S. Provisional Patent Application No. 62/068,780, filed on Oct. 27, 2014, for “Means and method for acquiring marine seismic data using non-uniform spatial sampling,” the entire contents of which are incorporated in their entirety herein by reference.

### BACKGROUND

Technical Field

Embodiments of the subject matter disclosed herein generally relate to optimizing seismic data acquisition, more specifically, to various techniques for diversifying source-receiver parameters so as to achieve higher quality images of explored structures as a result of processing the seismic data.

Discussion of the Background

Seismic surveys are useful for a variety of applications, such as environmental monitoring, agriculture, mining and seismology. As the economic benefits of such data have been proven, and additional applications for geophysical data have been discovered and developed, the demand for localized, high-resolution and cost-effective geophysical data has greatly increased. This trend is expected to continue.

During seismic surveys, seismic receivers (e.g., geophones, hydrophones, accelerometers, etc.) detect seismic waves reflected from an explored structure (which is underground or under the seafloor). The seismic receivers sample the detected waves to generate seismic data.

A typical marine seismic data acquisition system (also known as a spread) is illustrated in FIG. 1. A vessel 101 tows a source array including source elements 102 (e.g., air guns). When one or more source elements are activated (e.g., fired) seismic waves (i.e., acoustic energy whose time variation forms a signal) propagate in all directions. Some waves penetrate seafloor 104 into the explored geophysical formation 105. The formation includes multiple layers through which the seismic waves propagate with different speeds, causing the waves to be at least partially reflected at interfaces between the layers, such as 106. The reflected waves (e.g., 108, 110) travel upward to be eventually detected by receivers 112 carried by streamers 114 (only one shown in this vertical view). Wave path 108 corresponds to a longer offset (source-receiver distance) than wave path 110, but carries less energy (the longer the wave path, the more energy is attenuated/dissipated). Besides less energy, waves at longer offsets also have less energy at higher frequencies in the range of interest (which is from a few Hz up to 100 Hz). For example, the bandwidth is about 100 Hz for offsets up to 2 km, but decreases to 25 Hz at offsets of about 8 km.

As previously mentioned, a vessel usually tows plural streamers that form a streamer spread. The streamers may be up to 10 km long and carry receivers placed at regular intervals between 3 and 25 m (e.g., 12.5 m) along the streamer's length. Cross-line distance between streamers is greater than 50 m (e.g., 120 m) to avoid entangling. A vessel's towing capacity is limited; for example, it can pull up to 100 km of streamers (e.g., 10 streamers of 10 km or 5 streamers of 20 km). The longer the streamers and the smaller the cross-line interval between them, the greater the risk of entanglement, which causes loss of data acquisition time, and even equipment damage.

Conventionally, inline and cross-line sampling objectives are to observe sufficient resolution, a redundancy of multi-path coverage, and to minimize aliasing. The conventional seismic receiver arrangement has been characterized by repetitive/uniform patterns, such as a grid of receivers above an explored surface, receivers placed at equal intervals along streamers, streamers towed by a same vessel maintaining their depth relative to the water surface (i.e., horizontal) and having equal distances there-between, etc.

On land and marine detection, receiver arrangement is conventionally designed to observe a dynamic effect, known as moveout, as a function of offset distance and azimuth between the source and the detector. Moveout is a geometrical effect observed in seismic data and allows estimation of sub-surface properties like propagation velocity. Multiplicity of the receivers has beneficial effects on multi-path observations of the subsurface and the resultant S/N ratio of the seismic images.

In the case of towed receivers, image blurring occurs due to the receivers' motion during recording time. Simultaneous recording of reflections from plural sources (discussed in more detail later in this document) amplifies this problem.

The conventional arrangement of sources and detectors limits the spatial and temporal bandwidths, according to the Nyquist-Shannon sampling theorem. Cost and other practical considerations (e.g., deployment and retrieval, likelihood of damaging the equipment, etc.) are taken into account when designing an arrangement. For example, survey vessels cannot tow more than 16 typical streamers, and the minimum safe distance between streamers cannot be less than 50 m. Since receivers are usually placed uniformly along the streamer at 3-25 m intervals, cross-line sampling (i.e., in a direction perpendicular to the towing direction) is coarser than inline sampling (i.e., along the towing direction and, thus, the streamer). Measurement fidelity is therefore anisotropic due to different data, alias and noise sampling in these orthogonal directions.

Uniformity of the arrangements makes the Nyquist frequency predictable, with Fourier components measured linearly. Linear sampling inevitably means that many components are measured redundantly, with higher harmonics potentially containing energy leaked from lower frequency multiples (e.g., 8, 4, 2, etc.), i.e., aliasing.

Repetitive patterns have also been used in generating seismic waves. Conventionally, seismic waves are generated so as to avoid temporal or spatial detection overlap. If a seismic source includes multiple individual source elements, which are substantially collocated and activated to generate a stronger wave incident to the explored structure, in conventional data acquisition, the same activation sequence is used each time the individual sources are activated. This regularity makes it difficult to distinguish and remove noise, particularly noise that is seemingly coherent.

Recently, simultaneous recording of reflections from more than one source has been used to reduce the survey (acquisition) time and, thus, its cost. In this case, a receiver may detect overlapping signals due to reflections of waves with overlapping “recording” times, yielding so-called blended data. Separating the overlapping signals during data processing is an added challenge.

Accordingly, it has become desirable to design data acquisition to better separate signals from noise and from other signals and avoiding artifacts.

### SUMMARY

In various embodiments, data acquisition systems are optimized to diversify source-receiver parameters in order to enhance explored structures' images obtained after seismic data processing.

According to one embodiment, there is a method for diversifying source-receiver parameters in seismic data acquisition. The method includes maintaining an irregular arrangement of seismic devices that determine the source-receiver parameters, during the seismic data acquisition. The irregular arrangement departs in a predetermined manner from repetitive spatial patterns formed by or within groups of adjacent seismic devices. The method further includes acquiring seismic data and generating an image of a geophysical structure using the seismic data.

According to another embodiment, there is a method for diversifying source-receiver parameters during seismic data acquisition. The method includes determining source activation moments within each of a series of source firing time interval using Golomb ruler sequences or a non-linear inversion. The method further includes firing one or more sources according to the activation moments, respectively, to generate seismic waves. The method also includes recording, as seismic data, a sampled signal corresponding to seismic wave reflections emerging from a surveyed geophysical structure, wherein the seismic wave reflections related to at least two distinct among the generated seismic waves overlap in time and space. The generated waves are distinct if they have been generated at different moments and/or different locations. The method then includes generating an image of the geophysical structure using the seismic data.

According to yet another embodiment, there is a data acquisition system including sources configured to generate seismic waves able to penetrate a surveyed geophysical structure inside which the seismic waves propagate with different speeds and seismic receivers configured to detect reflections of the seismic waves emerging from the surveyed geophysical structure. The seismic sources and the seismic receivers are deployed according to an irregular arrangement departing in a predetermined manner from repetitive spatial patterns formed by or within groups of adjacent among the seismic sources or adjacent among the seismic receivers. The seismic receivers record seismic data generated based on the detected reflections, and usable to generate images of the surveyed geophysical structure.

According to yet another embodiment there is a computer readable medium non-transitorily storing executable codes which make a computer to execute a method for diversifying source-receiver parameters during seismic data acquisition. The method includes determining spatial intervals for an irregular arrangement of seismic sources and/or seismic receivers usable during a seismic data acquisition, and/or determining source activation moments within a source firing time interval. The irregular arrangement departs in a predetermined manner from repetitive spatial patterns formed by or within groups of adjacent among the seismic sources or adjacent among the receivers. The spatial intervals and/or the source activation moments are determined using Golomb ruler sequences or a non-linear inversion.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a generic marine seismic data acquisition system;

FIG. 2 is a graph illustrating random dithering in successive shooting periods;

FIG. 3 corresponds to FIG. 2, when all shooting periods are summed;

FIG. 4 represents spectra for different dithering time intervals when source activation dithering is random;

FIG. 5 represents spectra for different dithering time intervals when source activation dithering is based on Golomb ruler;

FIG. 6 is a schematic diagram used to explain the Fresnel zone;

FIG. 7 is a data acquisition system according to an embodiment;

FIG. 8 is a flowchart illustrating a method used to design the system in FIG. 7;

FIG. 9 is a flow chart diagram of a search procedure for selecting/finding a receiver geometry and/or combined receiver-source geometry with acceptable frequency response;

FIG. 10 illustrates amplitude A as a function of time for the seismic signal generated by the source and for the corresponding signal detected at the receiver;

FIG. 11 is a graph illustrating the spectrum of a detected signal;

FIGS. 12-15 illustrate spectra obtained for various embodiments;

FIG. 16 illustrates the spectrum obtained using streamer depths selected using a stochastic inversion method;

FIGS. 17-22 are sets of four graphs illustrating from left to right: streamer profiles, frequency content for each range of 1 km offset (nuances of grey corresponding to different energy levels), average spectrum for the streamer's length, and spectrum for the first 2 km of the streamers, respectively;

FIG. 23 illustrates maximum desired frequency (Hz) as a function of offset (x);

FIG. 24 is a flowchart of a method according to an embodiment;

FIG. 25 is a flowchart of a method according to another embodiment; and

FIG. 26 is a block diagram of a computer usable to calculate spatial intervals or activation moments for irregular arrangements used in embodiments.

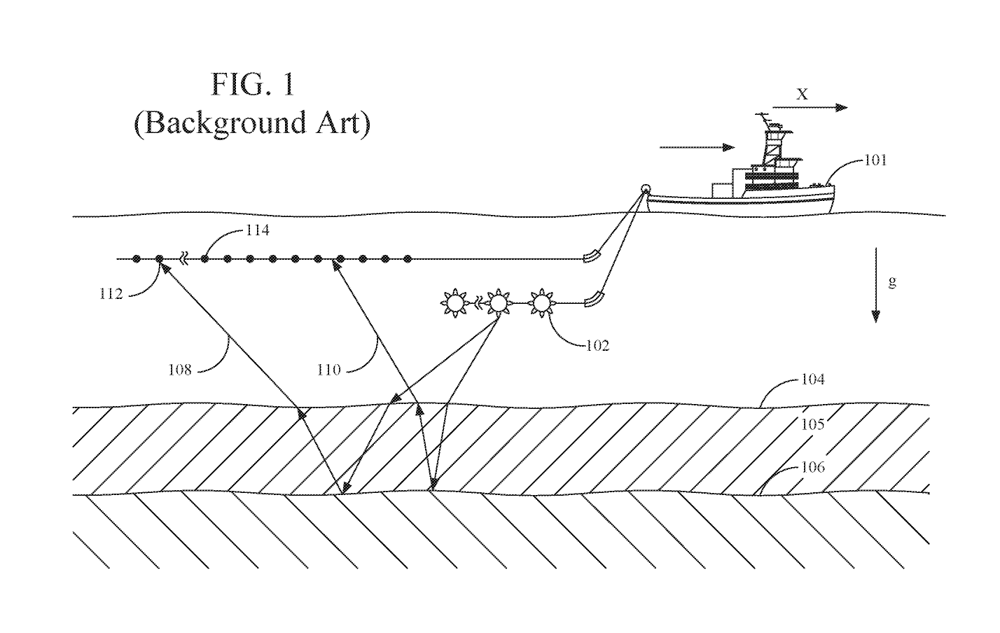

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed with regard to the terminology and structure of a seismic data acquisition system. However, the embodiments to be discussed next are not limited to seismic data acquisition, but may be applied to other forms of data acquisition, e.g. using electromagnetic waves.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

In various embodiments, seismic data acquisition geometry both on the receiver and source side are designed to observe system constraints and also to minimize survey cost. Temporally and/or spatially irregular sampling are used, the acquired data remaining sufficient to enable interpolation to a regular grid adequate for imaging the geophysical structure at a desired resolution.”

Source-receiver parameters of seismic data acquisition are diversified using predetermined irregular arrangements departing locally and/or globally, intermittently and/or continuously, from repetitive patterns (such as repetitive spatial patterns formed by or within groups of adjacent seismic sources or adjacent wave receivers). Seismic data is acquired when reflections of seismic waves generated by seismic sources to explore a geophysical structure are detected by seismic receivers. Diversification of source-receiver parameters leads to better extraction of information related to the geophysical structure, resulting in enhanced images thereof.

The following roadmap and subtitles used in this section aim to help the reader understand different aspects and objectives of various embodiments. A common thread is optimizing data acquisition using the Golomb ruler or non-linear optimization techniques. Irregularity may be implemented in data acquisition geometry (i.e., source and receiver positioning) and/or in wave generation timing.

Regarding data acquisition geometry, some embodiments focus on the position of data acquisition elements within groups (e.g., individual source elements of a source array, or receivers on a streamer) or among groups (e.g., source sub-arrays, streamers).

Data acquisition geometry may be varied within a group to achieve ghost diversity (e.g., by having group elements at different depths). Alternatively or additionally, data acquisition geometry within a group may be designed to achieve other objectives. For example, individual sources of a source array may be arranged to attenuate energy traveling in a given direction (e.g., directly to target receivers).

Relative positions of source arrays may be optimized for different (one or more) objectives, such as: ghost diversity, non-regular horizontal sampling, receiver spacing depending on wavefield complexity, etc.

Relative to ghost diversity, multi-level streamer spreads and/or multi-level sources may be used to achieve ghost frequency notch diversity and, thus, more uniform amplitude throughout the acquired data's bandwidth. Depths may be chosen to be at least in part proportional to Golomb ruler spacing. Alternatively, depths may be obtained using inversion to achieve spectral flatness within the bandwidth of the seismic data of interest and/or maximum average amplitude for a bandwidth of interest. Alternatively or additionally, streamers in a spread may have different shapes among horizontal line, slanted (with the same slant throughout the streamer's length, or portions with different slants along the streamer) or a variable depth shape including at least one curved portion.

Non-regular horizontal sampling in a horizontal plane is implemented to enhance interpolation (i.e., compressive sensing). Receiver spacing in a horizontal plane may be designed taking wavefield complexity into consideration. For example, streamer spacing may be changed with the offset based on aliasing or Fresnel zone. Streamers in a spread may thus have irregular spacing (i.e., different or varying cross-line intervals). Furthermore, survey plans may be designed to have irregular spacing between sail lines followed by towing vessels.

Irregularity may also be applied to wave generation timing. Golomb ruler timings may be used for simultaneous shooting. Simultaneous shooting means that energy emitted during a source excitation overlaps in detection with energy emitted during another source excitation. The overlapping source excitations may be due to the same (or collocated) sources or from sources at different locations. Alternative to using Golomb ruler timings, timings may be derived with non-linear inversion.

Seismic Data Acquisition Designed to Lower Cross-Talk Noise Level and to Improve de-Blending

Blended simultaneous recording of reflections due to two or more source activations is used to decrease data acquisition time and/or to increase offset and azimuth diversity or fold coverage during geophysical surveys. One among a sequence of different source activations is considered a master source firing (or shot), while the other one or more activations are slave sources firings (or shots). Slave source firings may occur earlier or later than the master source firing, from same location as the master source firing or from different locations.

The timing difference of the slave shots relative to the master shot is known as time-dithering or time-offsets. The maximum interval from the earliest to the latest source activation is less than a “recording time,” so that recorded data includes a blend of wave reflections generated during the different activations. In practice, recording may be continuous, with “recording time” segments being extracted from the continuous recording during data processing. The time and location of source firings are also recorded along with the receivers' positions.

During data processing, individual recordings (corresponding to each one of the shots) are extracted from the blended data. Individual records' start times are aligned with the respective shot time. However, mere time interval separation leaves reflection signals (energy) due to other shots than the targeted signal in the individual recording. Further various techniques are employed to attenuate these other interfering reflection signals. The process of extracting individual recordings and emphasizing the targeted signal is known as de-blending. Some de-blending techniques rely on the randomness of the interfering signals, either due to the different firing times or due to their orthogonality of spatial positions relative to the target shot. Algorithms may exploit the relative coherence of a signal to detect and extract its energy, attenuating the energy from interfering signals known as cross-talk. It is desirable that the cross-talk and other noise be minimized, i.e., the signal-to-noise ratio (S/N) be maximized in the processed data used for generating images of the explored structure.

Research into sparse sampling paradigms is enabled by new model space representations of data (e.g., curvelets), which permit data recovery by interpolation beyond conventionally accepted sample limits. Sparse sampling often requires randomness, particularly to minimize aliasing. Non-redundant Fourier sampling may lead to achieving the desired randomness.

Blended data acquisition and processing aim to obtain de-blended data (i.e., extracted and noise-attenuated individual recordings) nearly identical to data that could be obtained from unblended acquisition (i.e., without overlapping shots) for the same source-receiver pair. Processed individual recordings should preserve amplitudes sufficient for quantitative interpretive purposes (e.g., amplitude versus offset or azimuth, AVO/AVA, analysis) and be sensitive enough for time-lapse (4D) measurements (i.e., to identify changes in a geophysical structures by comparing surveys of the same area done at long time intervals—weeks, months, years).

Poor data acquisition design limits bands in temporal and spatial domains, resulting in loss of signal. In a marine environment, water-air surface reflections on the source and receiver side (known as ghosts) also interfere with the target signal. Ghosts may be varied (and thus easier to identify and attenuate) by adjusting sources' and/or receivers' depths. Loss of signal affects bandwidth in all domains (e.g., both time and space). Simultaneous acquisition may also yield inconsistent S/N ratio over the recording space and time domains. Therefore, data acquisition is designed to try to minimize band limitations in all relevant domains simultaneously.

The timing of blended shot firings with respect to their overlapping counterparts is varied by different advance or delay times to enhance the ability to separate overlapping signals. Slave shots are fired at different times prior to or after the master shot. Reflections of the master shot are coherent, while reflections from slave shots appear incoherent from shot to shot.

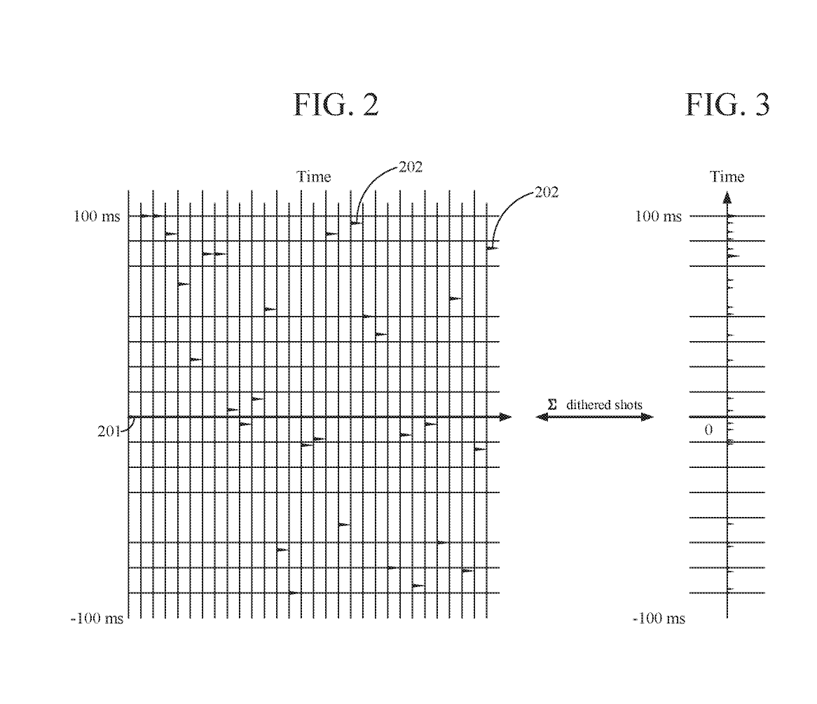

The dithering time is limited to the “recording” time and, if a blended individual recording includes no more than two shots, their energy may be too coherent for separation. FIG. 2 illustrates shooting periods (time along y-axis, each period occupying a different position on x-axis) in which the master shot 201 occurs at “0” in each period and a slave shot, 202, occurs randomly during each period. FIG. 3 shows on y-axis the sum of the shooting periods in FIG. 2.

Conventional de-blending algorithms use groups of common traces from many master source firings. Signal energy from the master sources is coherent, whereas signals from slave sources should be incoherent. A number of common traces are selected to cover a spatial extent over which the explored structure is consistent enough to contain coherent events. This characteristic may be expressed as a spatial filter length over which to observe coherent energy in order to separate it from the noise including the incoherent cross-talk energy from blended sources. The filter length, in records (or traces), may be chosen to be less than or equal to the number of different dither times to avoid coherent cross-talk artifacts generated by repetition in dithered time sequence. These de-blending methods are compromised when the analysis area lacks seismic events or contains high levels of other noise. Larger time window patterns are required to extend the recoverable bandwidth of low temporal frequencies to achieve low levels of cross-talk frequencies over desired seismic bandwidth. Short time differences between firings of cross-talk sources result in a high level of cross-talk noise. If the degree of overlap is smaller, less low frequency noise is generated. The lowest frequency that can be successfully deblended is related to the minimum time dither (see, e.g., “An Overview of BP's Marine Independent Simulations Source field trials,” by R. Abma et al., published in SEG Technical Program Expanded Abstracts 2012, related to SEG Las Vegas 2012 Annual Meeting).

In some embodiments, distribution of source firings within any one dithering pattern is chosen to minimize the redundancy of Fourier components. Dither times between the master and the slave shots are chosen according to the harmonic interference there-between. That is, the pattern of dithered delay times is selected so as not to promote any one Fourier component over another (i.e., a non-redundant Fourier components distribution).

It has been observed that longer durations of dithering time range lower the level of cross-talk noise at low frequencies (e.g., up to 20 Hz). FIG. 4 is a graph of amplitude versus frequency in a 0-20 Hz frequency range for random dithering within different time ranges. Lowest overall amplitude and flatter spectra are desirable. Line 401 corresponds to a dithering time range of 100 ms, line 402 to a dithering time range of 200 ms, line 403 to a dithering time range of 400 ms, and line 404 to a dithering time range of 800 ms. One observes that the larger the dithering time range the lower the level of noise at low frequencies.

Golomb ruler sequences (or simpler “Golomb sequences”) may be used for dither sequences to minimize the redundancy of Fourier components. Golomb sequences are groups of ordered integer numbers in which the interval between the numbers does not repeat. A group is characterized by how many numbers are in the sequence, known as “order,” and the highest number in the sequence, known as “length.” For example, Golomb sequences “0 1”, “0 1 3” and “0 1 4 6” have orders 2, 3 and 4, and lengths 1, 3, and 6, respectively. There may be several sequences for the same order, and they may have the same length; for example, “0 1 4 9 11” and “0 2 7 8 11” are both order 5 sequences of length 11. Determining these sequences and the shortest length for each order is an increasingly challenging task as the order increases. For example, the shortest length (553) for order 27 was recently solved (in February 2014) after five years of computation by some 20,000 distributed CPUs.

Other irregular patterns and sequences may be used: Costas array (i.e., 2D version of Golomb ruler), Sparse ruler, Perfect ruler, Sidon sequence, Wichmann ruler, Hall-Littlewood polynomial, Littlewood polynomial, Shapiro polynomial, Complementary sequence, Gold code, Kasami code, Zadoff-Chu sequence, Chu sequence, Frank-Zadoff-Chu (FZC) sequence, Polyphase sequence, etc.

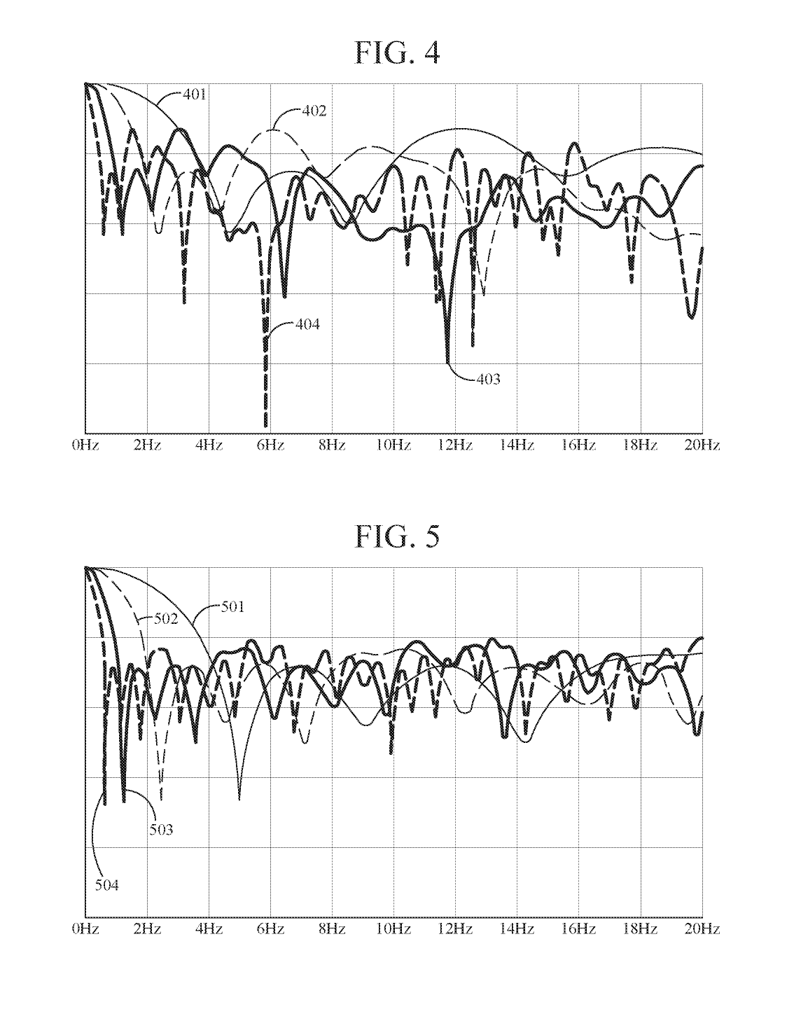

Studying the influence of dithering time range on the overall average amplitude and spectra's flatness when using Golomb ruler dithering, has again shown that, as in the case of random dithering, the longer the duration of dithering time range, the lower the level of cross-talk noise at low frequencies (e.g., up to 20 Hz). Similar to FIG. 4, FIG. 5 is a graph of amplitude versus frequency in a 0-20 Hz frequency range for Golomb ruler dithering within different time ranges. Line 501 corresponds to a dithering time range of 100 ms, line 502 to a dithering time range of 200 ms, line 503 to a dithering time range of 400 ms, and line 504 to a dithering time range of 800 ms. This graph reveals that again the larger the dithering time range the lower the level of noise and the flatter the spectra.

When using Golomb sequences for dithering, the order of the sequence is chosen to be as long as or longer than the typical coherence filter to be used within the de-blending algorithm. The length of the coherency filter defines how much data the filter considers in one processing window. The Golomb sequence is at least as long as the filter to ensure that the filter only sees data that does not contain repeating dither times.

The sequence may be scaled up or down to match the desired extent of the dither time window. For example, if a Golomb ruler sequence of order 5 and length 11 is used for a maximum delay time window length of 110 (ms) length, the values in this sequence may be multiplied by 110/11=10, to yield a sequence of delays giving 0 20 70 80 110 ms. The sequences may be used both to advance and to delay slave firing times. The number may be shifted by subtracting a same number from the sequence, an operation which does not change the desired Fourier frequency spectrum shape. As explained by K. Drakakis (in Advances in Mathematics of Communications, Vol. 3, No. 3, 2009, pp. 235-250) the Golomb ruler property remains invariant under affine transformations and linear shifts.

In one embodiment, a vessel tows a source including two sub-arrays of individual elements (e.g., air guns). The sub-arrays are fired independently. When fired with overlapping recording times, one of the sub-arrays is fired at regular time intervals (i.e., the master shot), and the other one is fired before or after the master shot according to different Golomb time interval delays or advances. For example, using the Golomb ruler order 27 (i.e., “0 3 15 41 66 95 97 . . . ”) the slave time distance from the master shot is 3 ms, 15 ms, 41 ms, etc. A set of seismic shots is repeated after Order-1 (where Order stands for the Golomb sequence's order) master shots. In order to use positive and negative firing times, the average Golomb number may be subtracted from the sequence as a constant. In addition, to increase or decrease the maximum time shift the Golomb numbers may be scaled by a constant.

In another embodiment in which a large number of sources are employed, each slave source may use a different dither time. If the embodiment has one master source and N slave sources, the Golomb sequence repeats every (order−1)/N master shots.

Dither times may be reordered to have an order other than the ascending order to avoid imparting structural features into the images due to the dithering order. Spatial-sequential usage of dither times is applied to avoid generating apparent spatial trends. In other words, the dithered times are used to minimize redundancy or resultant spatial Fourier wave-number components.

An optimum source firing sequence is such that the temporal-spatial “length” between each pair is unique and the maximum length is minimal Achieving this optimum may be pursued using non-redundant arrays (NRA) (e.g., Golomb rectangles, Costas arrays, and hexagonal arrays). An NRA in the context of blended acquisition is 2D grouping of aligned master shot and blended dither shots arranged optimally as a temporal and spatial pattern. Inverse autocorrelation may yield such a solution. Since the Golomb properties are preserved by transformation or affine scaling, the spatial and temporal axes may be normalized.

The same optimum sequence should be used for simultaneous source acquisition in surveys used to analyze evolution (known as time-lapse or 4D surveying) of a surveyed formation to ensure the same (low) cross-talk noise level. Data acquisition differences between surveys used in 4D analysis are deliberately minimized so as to observe physical changes in the surveyed formation. If the reference survey (i.e., the earliest) was acquired conventionally and a later survey uses blended acquisition, using the optimum dither for the later survey ensures that its cross-talk noise level is low so that the comparison with the reference survey is dominated by the real changes occurring in the surveyed formation. Additional (later) surveys for the same formation may be acquired with the same optimum dither.

The source timing and spatial jittering are known as dithering and jittering. The same approach can be applied to receiver arrangements. Detection of multiple blended sources may be performed by irregularly arranged receivers, e.g., based on Golomb ruler sequence. Such irregular arrangements yield optimum non-redundant increments in source-receiver offset space, achieving non-redundant Fourier sampling. Sparser spatial sampling may make reconstruction/interpolation of the seismic data necessary.

Non-redundant Fourier sampling offers a potential avenue to relax or remove spatial and temporal bandwidth limitations observed in conventional data acquisition systems. Curvelets (such as the ones developed at the Seismic Laboratory for Imaging and Modeling, University of British Columbia, see, e.g., “Nonequispaced curvelet transform for seismic data reconstruction: A sparsity-promoting approach” by G. Hennenfent, L. Fenelon, F. J. Herrmann published in Geophysics, Vol. 75, No. 6, November-December 2010, pp. WB203-210) have been used to reconstruct data acquired using spatially random under-sampling or uniform jittered under-sampling. Development of such methods enables replacing uniform sampling with arrangements designed to achieve non-redundant Fourier components. These arrangements would record less data but minimize artifacts such as aliasing.

In different embodiments, regular sampling may be replaced with irregular spatial sampling to various extents. This type of change affects other metrics, such as the source-receiver offset and azimuth distributions. These domains seem to tolerate reduced sampling without undue loss of information. For example, wave travel time, T_{d}, (from the source to a reflector and then the receiver) has mainly a quadratic relationship with offset d and wave propagation velocity v:

T_{d}=\sqrt{(T₀²+d²/v²)} (1)

where T₀ is zero offset arrival time.

The expression of azimuthal effects such as anisotropy is dominantly elliptical to second order. Only a few (typically four) azimuths are required to find the relevant parameters for this effect, so azimuthal sampling may be relaxed. The change from conventional uniform sampling to irregular sampling may actually induce beneficial azimuthal variation.

The above-described methodology proposed for blended acquisition may be extended to modeling. Modeling is used for imaging and inversion studies such as reverse time migration (RTM) and full wave inversion (FWI). In order to reduce the high costs of modeling, several shots may be combined in a manner similar to simultaneous recording. The combined shots may be later (e.g., after propagation through the explored formation), separated as convenient. In the case of FWI, the modelled blended shots may be used directly to calculate the cost function for inversion. Compounding and separation is subject to the same effects as blended acquisition and de-blending.

The following statements summarize this sub-section. In various embodiments the sampling is not regular and not random, but irregular, departing in a systematic manner from repetitive patterns. Temporal dithering during simultaneous shootings is deliberately chosen to lessen harmonic interference of blended shot energy and, consequently, to minimize the cross-talk noise level over the whole desired seismic spectrum. If de-blending using a coherence filtering method is going to be used, the ordering of the dithered sequence in the spatial domain is optimally chosen according to non-redundant Fourier properties to minimize coherent spatial artifacts. The same optimum sequence can be used for simultaneous source acquisition surveys, and particularly any repeat survey for the same surveyed formation usable in time-lapse (4D) analysis, to maximize the similarity of data acquisitions.

Selecting Sampling Positions or Blended Time Shifts

Separation of energy from different sources is enhanced if instead of using constant, dithered independent acquisition or random shifts, the time shifts are optimized to minimize the redundancy of Fourier components. This strategy may be employed in single or multi-vessel acquisition, with two or more sources that may include air guns, pingers, boomers, dynamite, vibroseis, marine vibrators, etc.

Further, individual source or receiver elements positioning may also follow an irregular arrangement, departing in a systematic manner from repetitive spatial patterns formed by or within groups of adjacent individual elements. For example, the source elements of a source may be placed at different depths (multi-level sources). The source elements may be fired according to a sequence, ensuring constructive interference amplifying down-propagating seismic waves. Source ghosts may have delays related to the ratio of the source element's depth and velocity of the seismic wave in water. In one embodiment, source elements' depths are selected to optimally attenuate source ghosts. Receiver elements may be arranged similarly to source elements to optimally attenuate receiver ghosts.

In other embodiments, during land or marine acquisition, the position of source and receiver elements may be optimized to attenuate horizontally traveling energy (e.g. energy travelling along a towed streamer) or ground/mud roll.

Considering now arrangement or groups of individual elements, their position may be optimized to improve interpolation or noise mitigation. For example, the irregular arrangement departing systematically from repetitive spatial patterns may be applied to streamer spacing, receivers along a streamer, ocean bottom or land node/receiver spacing, ocean bottom or land cable spacing, shot spacing along a vessel acquisition line, etc.

For example, a receiver arrangement may include 10 streamers towed at different depths to optimize receiver notch diversity for subsequent 3D receiver deghosting. Golomb ruler 11 sequence (“0, 1, 4, 13, 28, 33, 47, 54, 64, 70, 72”) may be used. If maximum receiver depth is 15 m, the sequence may be scaled by a factor 15/72. The first position may be related to the sea surface, leaving the 10 streamers at depths 0.2, 0.83, 2.7, 5.8, 6.9, 9.8, 11.3, 13.3, 14.6, and 15 m. The streamers at these depths may be randomly distributed in a horizontal plane or their order may be derived optimally. If some of the derived streamer depths are too shallow, the shallow depths may be eliminated. For example, six streamers at 6.9, 9.8, 11.3, 13.3, 14.6, and 15 m may be deployed instead of ten streamers. In order to maintain the deployment of 10 streamers, it may necessary to choose a longer Golomb ruler and to eliminate the lower numbers.

The sampling or timing may be optimized based on a known algorithm (e.g., data regularization using an optimized sinc operator), based on non-linear inversion or may use known sequences (such as the Golomb ruler). Data regularization refers to choosing timings optimally for a specific algorithm and/or objective rather than an overall optimization. A non-linear inversion method based on a stochastic inversion flow to minimize cross-talk noise includes the following steps:
1) Estimate noise based on random timing;
2) Calculate contamination estimate associated with the blended noise (e.g., root-mean-square, RMS, amplitude of the stack of blended noise within a frequency range of interest);
3) Randomly select a trace from the stack;
4) Modify the time shift for the trace by a random amount within a specified user limit (e.g., 50 ms);
5) Recalculate contamination estimate, and if the contamination is decreased, the time shift is kept; otherwise, it is discarded;
6) Repeat steps 3-5 until a minimum contamination has been reached.

A method for optimizing sampling for data regularization may be outlined as follows:
1) Receive a regular dataset;
2) Receive an irregular sampled version of the regular dataset based on random positions;
3) Use an anti-leakage transform (see, e.g., the article “Antileakage Fourier transform for seismic data regularization in higher dimensions” by S. Xu et al., published in Geophysics, Vol. 75, No. 6, November-December 2010, pp. WB113-120) to interpolate data received at 2) to positions of data received at 1); 4) Calculate RMS difference between data received at 1) and data obtained at 3);
5) Select a trace randomly;
6) Modify spatial position randomly within a given tolerance (e.g., a +/−5 m range); recalculate the synthetic data based on the new position;
7) Use the anti-leakage transform to interpolate the recalculated data from 6) to positions of data received at 1);
8) Calculate revised RMS difference between data received at 1) and data obtained at 7) and compare with the RMS difference calculated at 4); if the difference decreased, the modified position is kept; otherwise, it is discarded;
9) Repeat steps 5-8 until a minimum root-means-square (RMS) difference has been found.

A cost function may be calculated over the frequency range of interest (which may be in the time and/or spatial direction).

Alternatively, other minimization methods may be used such as: Gauss-Newton, Marquart-Levenberg, Ridge regression, Nelder-Mead (simplex) search, David-Fletcher-Powell Method, steepest descent, conjugate gradients, etc.

Optimal sampling or timing may be obtained using a Jacobian matrix of partial derivatives that may be computed numerically or analytically. If optimal shifts for blended acquisition are chosen, the partial derivative matrix may relate to the change in cost function with a time shift for each of the traces.

Acquiring marine seismic data with non-uniform spatial sampling

It has been observed that data recorded at near offsets has higher frequency content than data recorded at long offsets. Finer spatial sampling is required to use the high frequencies in the range of interest (i.e., 5-80 Hz). Near offsets data provides most of the high-frequency energy, HFE, because HFE quickly stacks out if common midpoint or common image point gathers are not sufficiently flat. While it is relatively straightforward to flatten near offsets (without much normal moveout), it is more challenging to flatten longer offsets. HFE at mid- to long offsets is often limited in value and significantly distorted due to normal moveout stretch.

In view of the above observation, one way to optimize data acquisition is using variable length streamers towed behind a vessel to achieve finer cross-line sampling for the near offsets and coarser sampling for the longer offsets. The same sampling strategy may be applied for inline spacing. This approach reduces the amount of equipment or, using the same amount of equipment, acquires better data. For example, using some shorter streamers to provide fine spatial sampling only for near offsets enables using other longer streamers extending beyond typical length for longer offsets.

The arrival time t relative to a shot moment is expressed in two dimensions as:

$$t = \sqrt{( {T}_{0}^{2} + \frac{{h}_{x}^{2}}{{v}^{2}} + \frac{{h}_{y}^{2}}{{v}^{2}} )} \qquad ( 2 )$$

where T₀ is zero offset arrival time and v is the wave propagation velocity, hₓ and h_{y} are the inline and cross-line offsets, respectively.

Arrival time varies faster cross-line when inline offsets (hₓ) are shorter than when inline offsets are longer. Therefore, the apparent dip of the incoming energy with the cross-line offset (h_{y}) is higher (i.e., higher slowness/lower apparent velocity) at short inline offset than at longer inline offset. The maximum cross-line dip may be estimated using a model velocity profile and differentiating equation 2 with respect to the inline and cross-line offsets, respectively:

$$\begin{matrix}{p}_{x} = \frac{{h}_{x}}{{v}^{2} t} & ( 3 ) \\ {p}_{y} = \frac{{h}_{y}}{{v}^{2} t} & ( 4 )\end{matrix}$$

where pₓ and p_{y} are cross-line and inline slowness.

Denser sampling is required for higher dips to avoid aliasing. The maximum frequency fₘₐₓ at which data spatially aliases is given by:

$${f}_{max} \frac{v}{2 Δ x sin θ} = \frac{v}{2 vp Δ x} = \frac{1}{2 p Δ x} \qquad ( 5 )$$

where Δx is cross-line sampling step (e.g., distance between streamers). Streamer separation may then be calculated using the maximum frequency anticipated and the steepest dip expected as:

$$Δ x = \frac{1}{2 {pf}_{max}} . \qquad ( 6 )$$

The following table lists spatial sampling requirements for signals of different maximum frequency.

TABLE 1

| | 100 Hz | 50 Hz | 25 Hz |
|---|---|---|---|
| | Spatial | Spatial | Spatial |
| Slowness | sampling | sampling | sampling |
| (s/m) | (m) | (m) | (m) |
| 0.00066 | 8.333333 | 16.66666 | 33.333333 |
| 0.00055 | 9.090909 | 18.18181818 | 36.363636 |
| 0.0005 | 10 | 20 | 40 |
| 0.00045 | 11.11111 | 22.222222 | 33.33333 |
| 0.0004 | 12.5 | 25 | 50 |
| 0.00035 | 14.28571 | 28.57 | 57.14 |
| 0.0003 | 16.66667 | 33.33333 | 66.66666 |
| 0.00025 | 20 | 40 | 80 |
| 0.0002 | 25 | 50 | 100 |
| 0.00015 | 33.33333 | 66.66666 | 133.33333 |
| 1E−04 | 50 | 100 | 200 |
| 5E−05 | 100 | 200 | 400 |

Another criterion for trace spacing may be based on the Fresnel zone, which defines a spatial radius of data that constructively interferes in the migration process. Since Fresnel zone increases with offset, spatial sampling requirements change. A procedure known as Fresnel zone binning (described at http://www.cgg.com/default.aspx?cid=5801&lang=1) allows traces with larger spacing at long offsets than at short offsets.

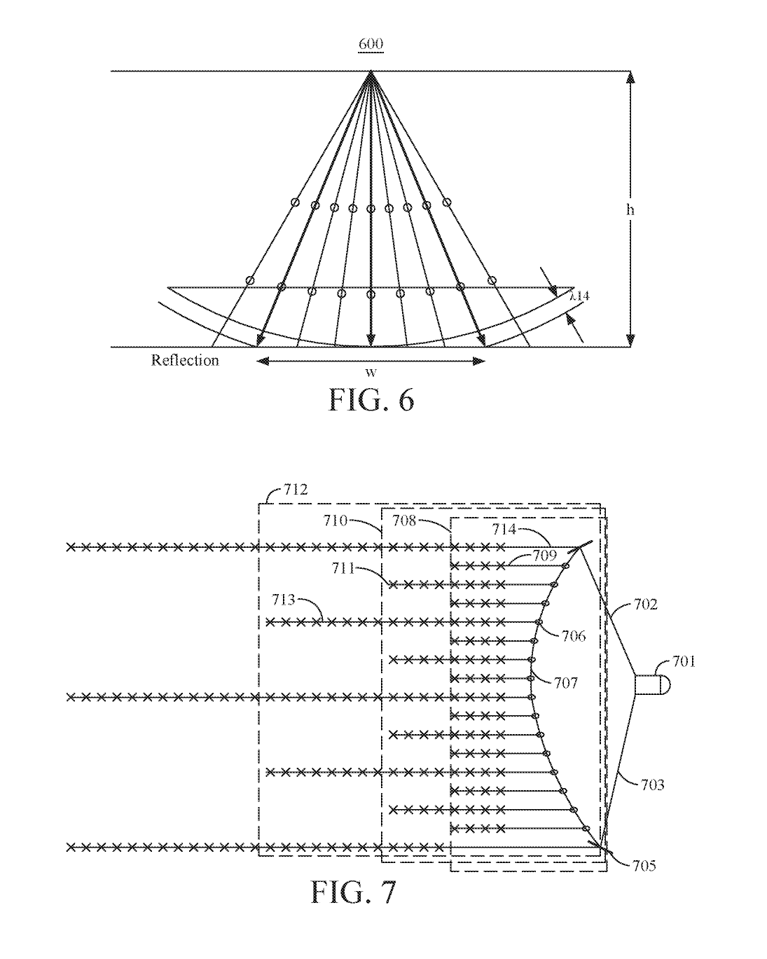

The Fresnel zone, which depends on the velocity profile of the subsurface, may be defined as follows using FIG. 6:

h²+(w/2)²=(h+λ/4)²

w²/4=(h²+hλ/2+λ²/6)−h²

w²/4=(h²+hλ/2+λ²/16)−h²

w²=2hλ+λ²/4

w²/4=(h²/2+λ²/16)−h²

λ²/4<<2hλ→w≅\sqrt{2hλ}

v=fλ→w≅\sqrt{2hv/f}

where h is inline distance from the source 600 to a sampling zone, Δ is the wave frequency and w width is the size of a Fresnel zone. Calculating w allows to estimate how much the spatial sampling requirement can be relaxed. The wider the zone, the coarser can the sampling be without losing information about the subsurface.

It is known that bandwidth of the reflections detected by receivers decreases with offset (e.g., at 0-2 km it is possible to recover up to 100 Hz, up to 4 km up to 50 Hz, up to 8 km up to 25 Hz). Since lower frequency needs less dense sampling to avoid aliasing, wider stream separation becomes acceptable at larger offsets.

FIG. 7 illustrates a data acquisition system 700 with different streamer cross-line separation along the streamer spread. Vessel 701 is connected to lead-in cables 702 and 703 that have deflectors 704 and 705, respectively, at their distal ends. At tow points (only one labeled 706), 17 streamers are attached to a space rope 707, which is connected between the deflectors. The data acquisition system is designed for a vessel able to tow up to 100 km of streamers and aims to detect reflections with a bandwidth up to 100 Hz up to 2 km, up to 50 Hz up to 4 km and up to 25 Hz up to 8 km. The necessary sampling interval is inversely proportional with the highest frequency intended for recovery. Therefore, recovering up to 100 Hz needs half the cross-line interval than for 50 Hz, etc. The streamers may be towed horizontally at a constant depth or have a variable depth profile maintained, for example, using an ultrasonic positioning system (such as Nautilus produced by Sercel). Each streamer may have a tail buoy equipped with a GPS receiver to provide additional positioning information.

Four regions can be defined based on the cross-line separation. All streamers extend in the near offset region 708 (e.g., up to 2 km from the source), while having substantially equal cross-line distances between them (e.g., 30 m). Every other streamer (such as 709) does not extend beyond the near-offset region. The shorter length of streamers 709 enables better streamer control and lowers the danger of entanglement.

The other streamers that extend in the mid-offset region 710 (e.g., 2-4 km from the source) have substantially equal cross-line distances (e.g., 60 m), which are double the cross-line distances in the near offset region. Every other streamer in the mid-offset region (such as 711) does not extend beyond the near-offset region.

The streamers that extend in the long offset region 712 (e.g., 4-8 km from the source) have substantially equal cross-line distances (e.g., 120 m), which are two times the cross-line distances in the mid-offset region and four times the cross-line distances in the near offset region. Every other streamer in the long offset region (such as 713) does not extend beyond the long offset region.

Beyond the distal edge of long offset region 712, streamers such as 713 have cross-line distances (e.g., 240 m) that are two times the cross-line distances in the long offset region, four times the cross-line distances in the mid-offset region and eight times the cross-line distances in the near offset region. The larger distances between these longest streamers allow better control and, thus, longer streamers.

The total length of the 17 streamers is 8×2 km+4×4 km+2×8 km+3×16 km=96 km, which is within the vessel's towing capacity.

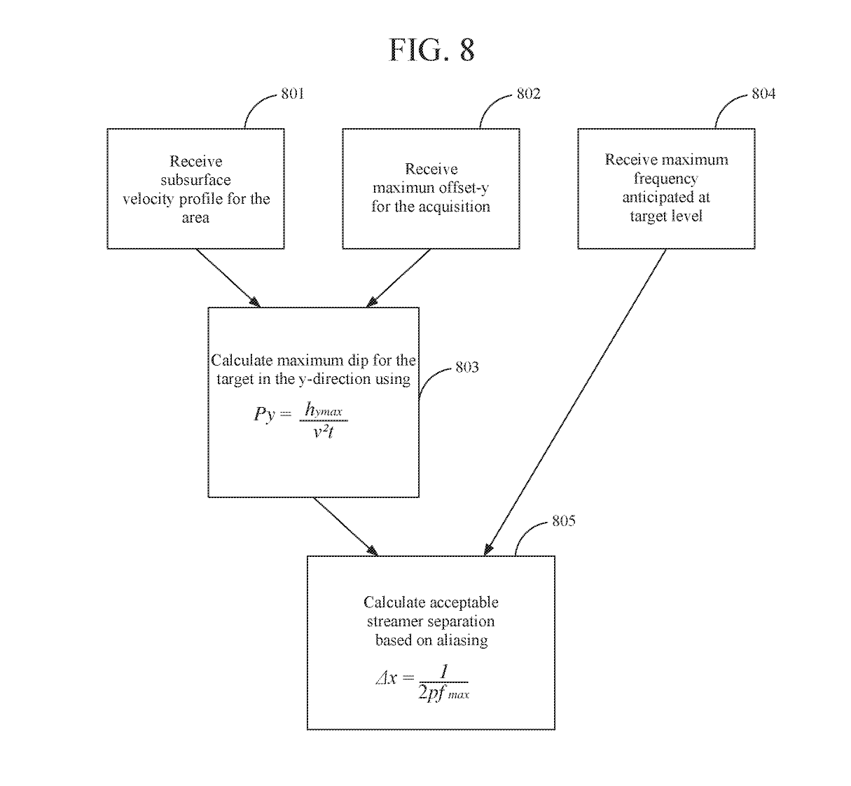

An arrangement such as in FIG. 7 may be calculated as shown in FIG. 8. The subsurface velocity profile received at 801 and the maximum offset-y for acquisition received at 802 are used at 803 to calculate maximum dip for the target in the y direction using formula (4). Acceptable streamer separation is then calculated at 805 based on aliasing (formula (5)), using the maximum dip calculated at 803 and maximum frequency anticipated at target level received at 804.

A cost/objective function J may be used for optimizing a data acquisition design. According to a non-limiting embodiment, J is a multivariable function that includes terms related to how closely geophysical objectives O are met, and operational considerations C (such as, system constraints). The cost/objective function may be combination of terms O and C, for example:

F(O,C)=O+C (7)

The overall objective is to use a limited amount of equipment or to optimize the use of the available equipment during a geophysical survey, to acquire a data set that may or may not be uniformly spatially sampled. Later in processing, through data regularization, the physical data that may be non-uniformly sampled can be transformed/interpolated to create an equivalent uniformly sampled data volume that can be then be used to generate images via a conventional processing flow.

A more detailed description of the terms that are used to represent the geophysical objectives integrated into the term “0”, and the terms combined to represent the term “C” follows. The paradigm is that a collection of receivers that occupies a three dimensional volume are towed behind a vessel. For simplicity, consider using spatial sampling only to achieve a geophysical objective. For this example, assume a Cartesian coordinate system (other coordinate systems are possible) with the origin on the water surface at the midpoint of the vessel stern, where positive x direction starts from the rear of the vessel and extends back, y is transverse from the x direction, and z corresponds to depth. Parameters useful for describing the geophysical objectives include (but are not limited to):
Δx is inline sampling (i.e., distance between receivers along the streamers which may be fixed during streamer's manufacturing),
Δy is crossline sampling (i.e., streamer spacing), and
Δz is the depth spacing.

Parameters Δx, Δy and Δz may be variable in x, y and z. Further, Nr is the total number of receiver groups, i is the receiver index, X is an array of receiver group x-coordinate locations (e.g., receivers along a streamer), Y is an array of receiver group y-coordinate locations, Z is an array of receiver group z-coordinate locations. Furthermore, ΔX is an array of receiver group spacing along the x-coordinate, ΔY is an array of receiver group spacing along the y-coordinate, ΔZ is an array of receiver group spacing along the z-coordinate. The choice of X, Y, Z and ΔX, ΔY, ΔZ after resampling/regularization gives rise to uniformly sampled data with spatial sampling dX, dY and dZ where: dX is an array containing the resultant receiver group spatial sampling after regularization along the x-coordinate, dY is an array containing the resultant receiver group spatial sampling after regularization along the y-coordinate, and dZ is an array containing the resultant receiver group spatial sampling after regularization along the z-coordinate. Thus, the geophysical objectives with regard to surface spatial sampling may be expressed as:

O=(dX)^{T}U(dX)+(dY)^{T}V((dY)+(dZ)^{T}W((dZ) (8)

where U, V and W are, for example, square diagonal matrices with positive weighting values along the principal diagonal. The weighting may be based upon the distance from the source. Optimizing equation 8 in combination with the operation constraints described below yields the finest spatial sampling possible given the constraints described below.

Operational/system constraints C are defined using the following parameters:
Ntow is the number of towed streamers,
max(X) is the maximum inline length of any towed streamer,
max(Y) is the maximum crossline offset,
max(Z) is the maximum depth of any of the streamers, and
Nsec is the number of streamer sections.

Corresponding operational limits may exist for minimum values as well, but for simplicity are not considered for this embodiment. Further:
LXmax is the maximum desired streamer length,
LYmax is the maximum desired streamer crossline offset,
LZmax is the maximum desired streamer depth,
LNsec is the maximum desired total number of streamer sections to be deployed, and
Tacq is the estimated time to acquire data during the survey.

The operational constraints C are then given by

C=a₁{max[max(Z)−LZmax,0]}ⁿ¹+a₂{max[max(Y)−LYmax,0]}ⁿ²+

a₃{max[max(X)−LXmax,0]}ⁿ³+a₄{max[(Nsec−LNsec),0]}ⁿ⁴+

a₅{N_{tow}}ⁿ⁵+a₆{T_{acq}}ⁿ⁶ (9)

where a1 . . . a6 are positive weightings, and n1 . . . n6 are positive exponents.

For equipment economy and greater flexibility, a sparse ruler spacing may be used in the crossline direction in certain situations to allow more and finer spatial sampling options after interpolation than a regular crossline spacing for a fixed number of sail lines. Plural sources (e.g., a flip flop shooting mode for airguns or some form of simultaneous marine vibrator source acquisition that uses pseudo-orthogonal sweep/signal encoding) may be used in a survey to achieve different source offsets. If plural source arrays are used, then the crossline streamer spacing/positioning optimization for such a survey becomes a joint optimization problem (i.e., optimizing for each of the sources). In this case, a cost/objective function, which has been designed to represent the cost function for the streamers (i.e., towed receiver lines), is combined/augmented to include the cost of operating multiple sources along with the receiver placement problem. The resulting joint objective is optimized.

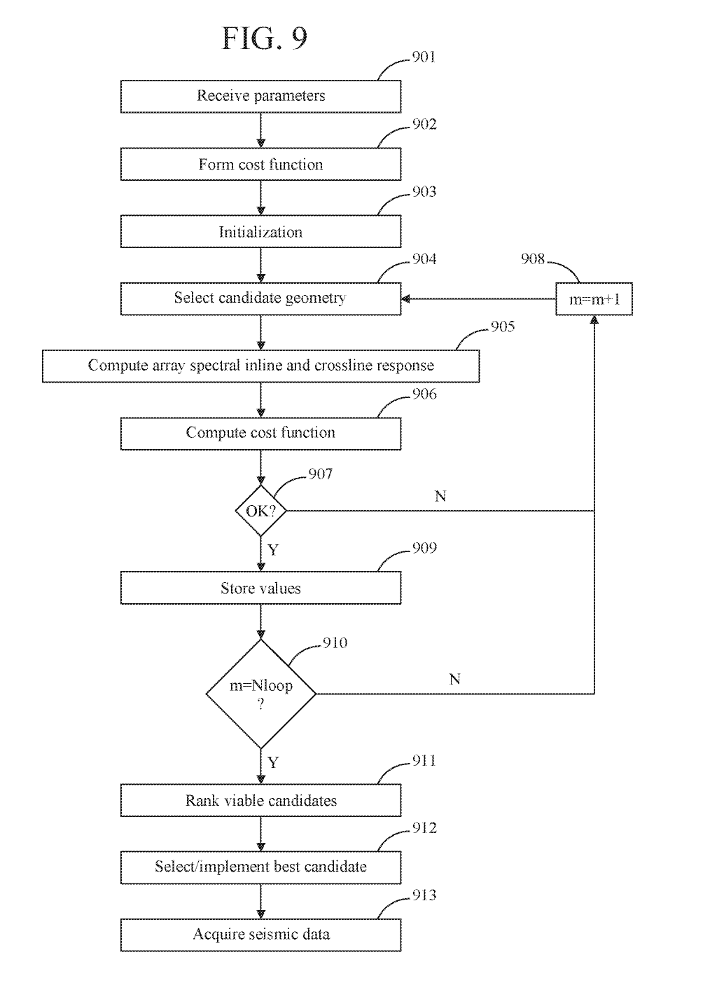

FIG. 9 is a flow chart diagram of a search procedure for selecting/finding a receiver geometry and/or combined receiver-source geometry with acceptable frequency response. The parameters necessary to form the cost function are provided at 901, and the cost function is formed at 902. An initialization of the process is performed at 903, for example, to obtain candidate geometries, set an acceptable limit for the cost function, initialize the looping index m, etc.

One of Nloop candidate geometries is selected at 904. At 905 the spectral inline and crossline responses are evaluated. At 906, the cost function is calculated for the candidate geometry, and its value is compared at 907 with the acceptable limit. If the calculated cost function value is not found satisfactory at 907, the looping index is incremented at 908 and steps 904-907 are repeated. If the calculated cost function value is found satisfactory at 907, its characteristics are stored at 909. If at 910 it appears that there are still candidate geometries to be evaluated (i.e., m<Nloop), the looping index m is incremented at 908 and steps 904-907 are reiterated. If there are no other candidate geometries to be evaluated (i.e., m=Nloop), the viable candidates (i.e., whose calculated cost function values have been found satisfactory, and characteristics have been stored) are ranked at 911, to select the best candidate geometry according to the rank, at 912. Data acquisition is performed using the best candidate geometry at 913.

The data acquired in this manner may be processed based on different strategies. One strategy involves applying data regularization in the shot-point domain, early in the processing. This approach may receive the irregularly spaced receivers for each shot in turn, calculate a model representation of the data (e.g., in f-Kx-Ky domain) which is then used to reconstruct data on a regular grid, or on hypothetical streamers based on the minimum streamer separation (close to the vessel). The models may be solved in small spatio-temporal windows within which the data may be assumed to be roughly linear. Different model domains may be used, e.g. tau-px-py, shifted hyperbola, etc. The model domain may be solved in a variety of ways, e.g. anti-leakage Fourier transform, iteratively weighted least squares inversion, etc.

Instead of regularizing the data early in the processing, the different streamers may be processed though the 2D and 3D processing sequence. It is common to regularize data prior to migration, which is often performed in the offset volume domain. The regularization scheme may be employed to regularize data to the same bin size for all offsets, thus harmonizing the y-direction sampling. Alternatively, the bin size may be increased for higher offsets based on the principles of Fresnel zone/aliasing as previously discussed.

A straightforward scheme to integrate the data set would be to interpolate the low frequency data so that, in processing, the same bin size could be used to process all the data. In other words, the low frequency and mid frequency data sets could be interpolated to estimate the data that would have been recorded had all the streamers been of the same length as the longest streamer.

In this embodiment, the streamers are all shown parallel (i.e., there is no feathering, that is variable slope of the streamers away from the sail line), but embodiments may include some feathering. Feathering provides another way to increase cross-line spacing with offset and could be used in combination with features of other embodiments described above.

### Marine Streamer Profile Diversity

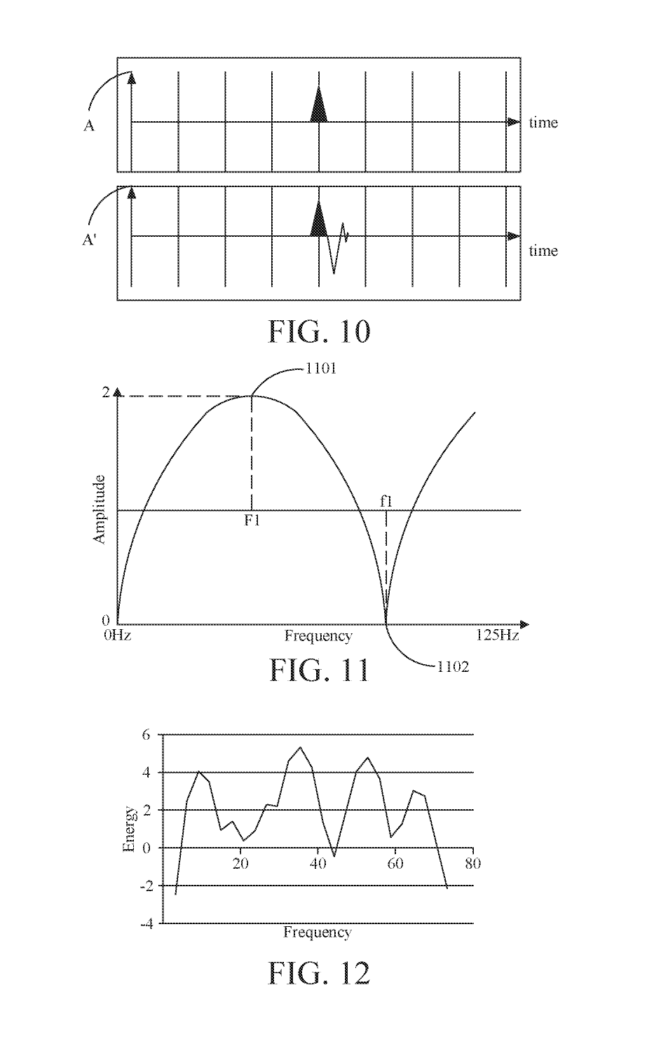

This section focusses embodiments for multi-streamer marine data acquisition, in particular to the use of different towing profiles for different streamers. As previously mentioned, reflections due to the air-water interface are ghosts and can occur both at the source and at the receiver side. For a plane wave, the receiver ghost is a delayed version with reversed polarity of the up-going signal corresponding to the targeted seismic waves. FIG. 10 illustrates amplitude A as a function of time for the seismic signal generated by the source in the upper half, and amplitude A′ as a function of time for the corresponding signal detected at the receiver. The detected signal includes the receiver ghost.

As shown in FIG. 11, the target signal and the ghost interferes constructively (yielding an increased amplitude) at some frequencies (e.g., 1101) and destructively (cancelling each other) at other frequencies (e.g., 1102). For vertical traveling energy (i.e., emission and detection locations align vertically), the n-th frequency notch fₙ is:

fₙ=nv/2z (10)

where v is the velocity of sound in water, and z is the receiver's depth. The n-th frequency peak occurs at frequency Fₙ, which is:

Fₙ=(n−0.5)v/2z. (11)

It is often necessary to try to remove the receiver ghost to uncover the true explored formation's response without the constructive/destructive interference of the receiver ghost. One way to achieve this is using particle motion sensors installed in the streamer (e.g. geophones, accelerometers, differential hydrophones, particle velocity sensors, particle motion sensors, etc.). While these sensors may provide a solution to remove the ghost at high frequencies, the low frequencies are often strongly contaminated by noise. For this reason, other solutions to the ghost problem have been sought.

One such solution is to deploy sensors at different depths so that there is a diversity in the position of the receiver notch and no individual frequency is deficient in energy. This strategy may be adopted by towing a variable depth streamer which may consist of a slanted cable, sinusoidal tow, or a BroadSeis streamer profile which begins with a slant and ends horizontally at the end of the streamer.

In some environments it may be of interest to increase the level of notch diversity at different offsets by towing different streamers within the spread with different profiles. Such different profiles may be:
A. horizontal line, which means that the streamer is substantially at the same depth relative throughout the streamer's length
B. slanted line, which means that the streamer's depth increases with a substantially constant rate throughout its length;
C. sinusoidal, which means that the streamer has a substantially sinusoidal or undulating shape in the horizontal and/or vertical plane;
D. BroadSeis profile, which means that the streamer's depth increases with two different rates along respective portions along its length,
E. Symmetrical BroadSeis profile which means that the streamer has a first portion (closer to the streamer's head) in which the streamer's depth increases at a constant rate along the portion's length, and a second portion (closer to the streamer's tail) in which the streamer's depth decreases at a constant rate,
F. a mixed profile including a first portion in which the streamer's depth varies at a constant rate and a second portion in which the streamer's depth remains constant, or
G. a flat-BroadSeis shape including a first portion in which the streamer's depth is constant and a second portion which has a BroadSeis profile.

Thus, some embodiments have a streamer spread including at least two streamers having different profiles among A-G listed above. For example, in one embodiment, some streamers have horizontal profiles, while other streamers have BroadSeis profiles. In another embodiment, some streamers may have first horizontal profiles, while other streamers have BroadSeis profiles (characterized by first increasing and decreasing rates), while other streamers have BroadSeis profiles (characterized by second increasing and decreasing rates different from the first increasing and decreasing rates). Streamers having a first profile may be towed at a depth different from the towing depth of streamers having a second profile (e.g., 9 and 50 m).

In some embodiments, a spread may include streamers characterized by more than two different profiles. For example, a spread may include 12 streamers each having a different profile. These may all be different BroadSeis tows, all different horizontal tows, sinusoidal tows with a mixture of phase, etc. A mixture of streamer shapes (A-E) may be used within the same spread.

A streamer's depth (which may be defined as average, minimum or maximum as appropriate) may be selected to achieve optimal spectra in terms of notch diversity. This optimization may be defined so as to have an average spectrum which is as flat as possible (when considering all streamers together) across all frequencies, or across a specified frequency range of interest (e.g. 2 to 80 Hz). The optimization may involve solving linear or non-linear equations.

One set of optimal depths or streamers in a spread may be defined using the Golomb ruler. The depths are calculated using a Golomb ruler sequence while taking into consideration also the minimum and maximum depth. The sequence numbers are scaled values within the depth range to yield the desired number of streamer depths. Golomb ruler numbers relating to cables shallower than required may be dropped as discussed previously. The use of Golomb ruler ensures that no two streamers are separated by the same depth difference as any other two streamers. As the notches frequencies are inversely proportional to the depth, choosing receiver depths using the Golomb ruler leads to an optimal diversity of the notches.

Spectra obtained using some specific embodiments in which streamer's depths have been determined using Golomb ruler are shown in FIGS. 12-15. Note that since Golomb ruler sequences are not unique at least because different sets of depths may be obtained for a given number of streamers.

FIG. 12 is the spectrum (i.e., energy as a function of frequency) of data acquired using a streamer spread with streamer's depths of: 7, 10, 18, 19, 21, 25, 33, 37, 41, 45, 48 and 50 m (the values are rounded to the closest integer).

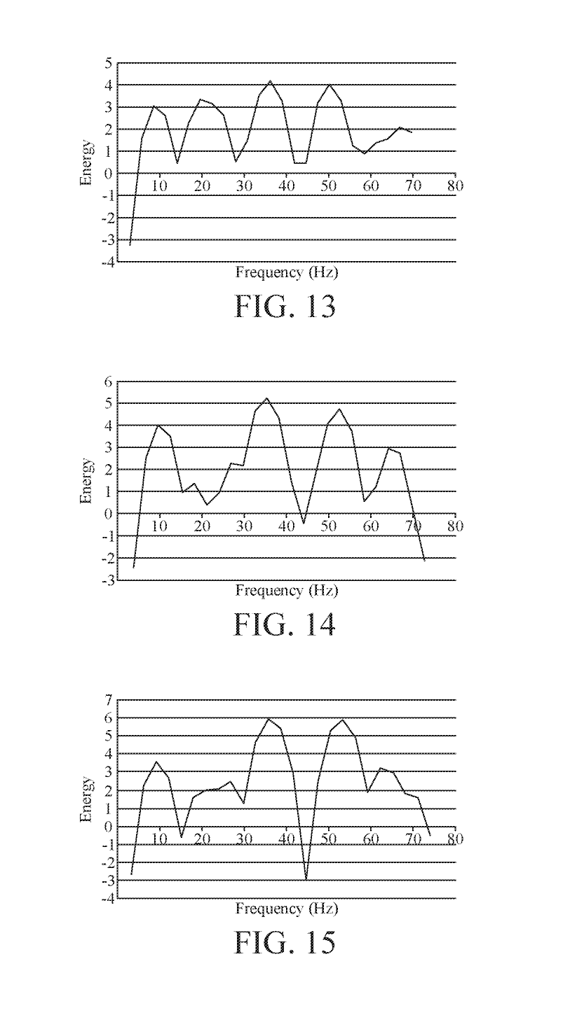

FIG. 13 is the spectrum of data acquired using a streamer spread in which the streamers have six different profiles and are towed at 6, 13, 22, 32, 47, and 50 m depth. FIG. 14 is the spectrum of data acquired using a streamer spread in which the streamers have four different profiles and are towed at 9, 31, 36 and 50 m. FIG. 15 is the spectrum of data acquired using a streamer spread in which the streamers have three different profiles and are towed at 8, 33 and 50 m.

In contrast to the single depth detection illustrated in FIG. 11, which yields a sharp notch, using several receiver depths makes the spectra to have fewer and less pronounced maxima and minima in FIGS. 12-15.

The data from each streamer may be deghosted independently, but it is also possible to deghost all streamers at the same time with 3D deghosting. This strategy may take advantage of ghost peaks in some cables at positions of ghost notches in other cables. The deghosting may be combined with wavefield reconstruction, which may involve generating data at positions different to the input data. For example, wavefield reconstruction may output data representative of the up-going wavefield at the sea surface on a fine Cartesian grid. Alternatively, the output wavefield may contain up-going and down-going waves at a new depth, for example, the depth of a baseline (previous) survey.

Calculating depths using Golomb ruler provides diversity, but these calculated depths are optimal in a general sense, and not necessarily optimal for the bandwidth of interest. Alternative to using Golomb ruler, the depth may be determined such that to optimize for flatness of the spectrum within a bandwidth of interest (e.g., 5 to 100 Hz). This optimization may include a linear or non-linear inversion based on a cost function to achieve a high amplitude flat spectrum in the frequency of interest. Any type of inversion scheme (e.g. stochastic, Monte Carlo, ridge regression, Gauss-Newton, etc) may be used for this purpose.

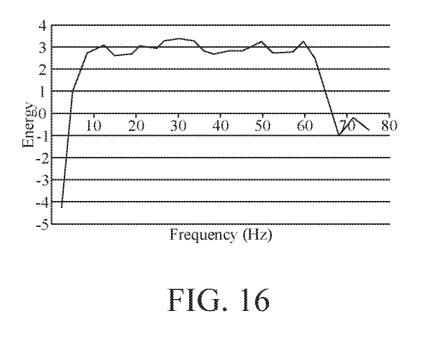

FIG. 16 is the spectrum of data acquired using a streamer spread in which the streamers are towed at depths (9, 10, 10, 11, 18, 20, 26, 32, 33, 40, 46, 55 m) obtained using a stochastic inversion method. While the spectrum shows amplitude dropping off after 60 Hz, a more detailed analysis shows that the spectrum is actually substantially flat to higher frequencies. The spectrum in FIG. 16 is much flatter than the spectra in FIGS. 12-15.

Instead of optimizing based on horizontal streamers, arrangements may be optimized more accurately when taking into account depth variation along the streamer (i.e., sum or integrate the contribution of every receiver in the spread, each receiver having a unique depth).

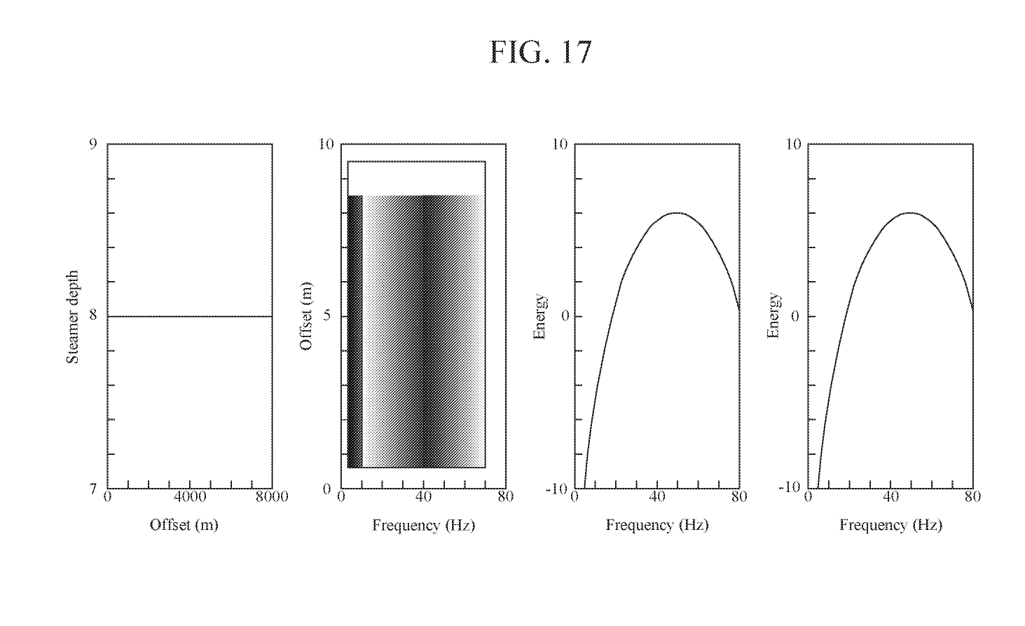

Monte-Carlo inversion may be designed to satisfy plural objectives such as: flattening the spectrum, maximizing average amplitude, maximizing average amplitudes in different regions, etc. FIGS. 17-22 are sets of four graphs illustrating from left to right in each set: streamer profiles, frequency content for each range of 1 km offset (nuances of grey corresponding to different energy levels), average spectrum for data acquired by the receivers along the streamer's length, and spectrum for data acquired by receivers in the first 2 km of the streamers, respectively.

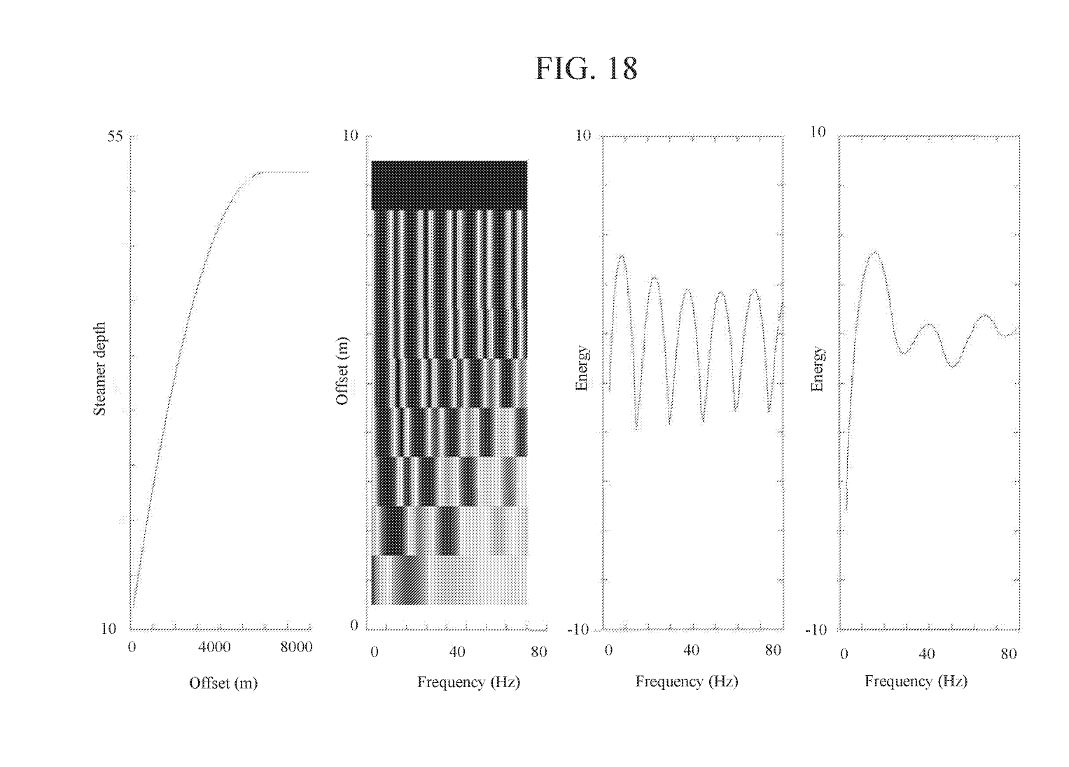

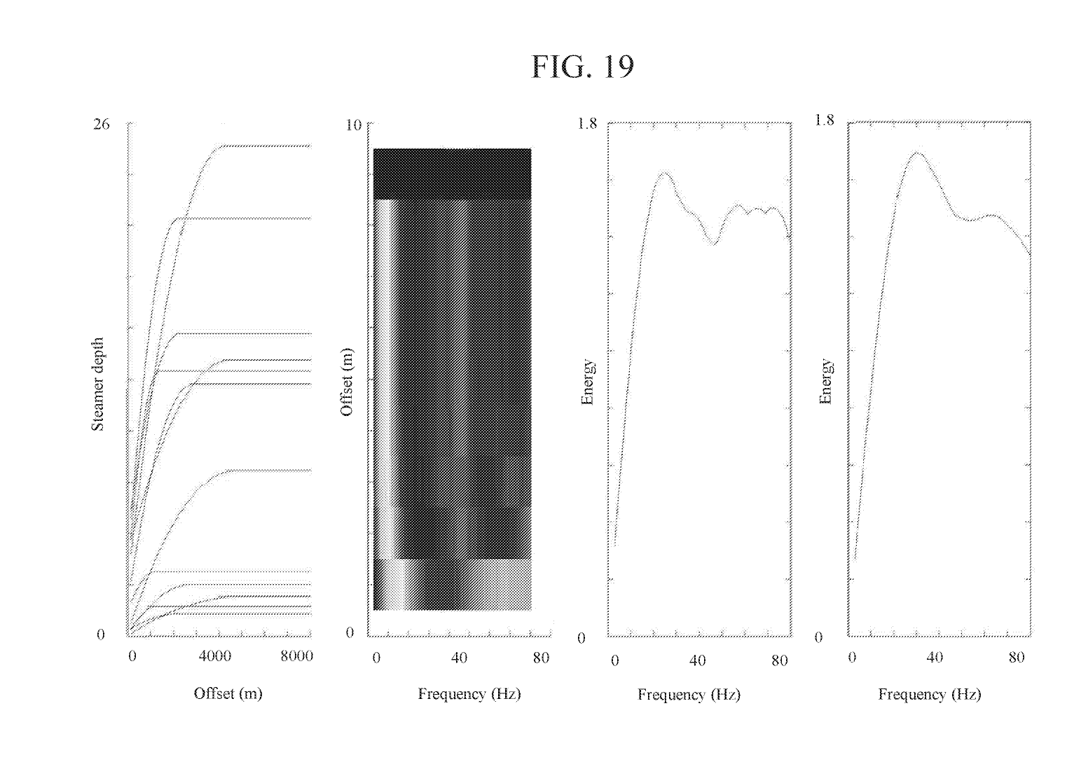

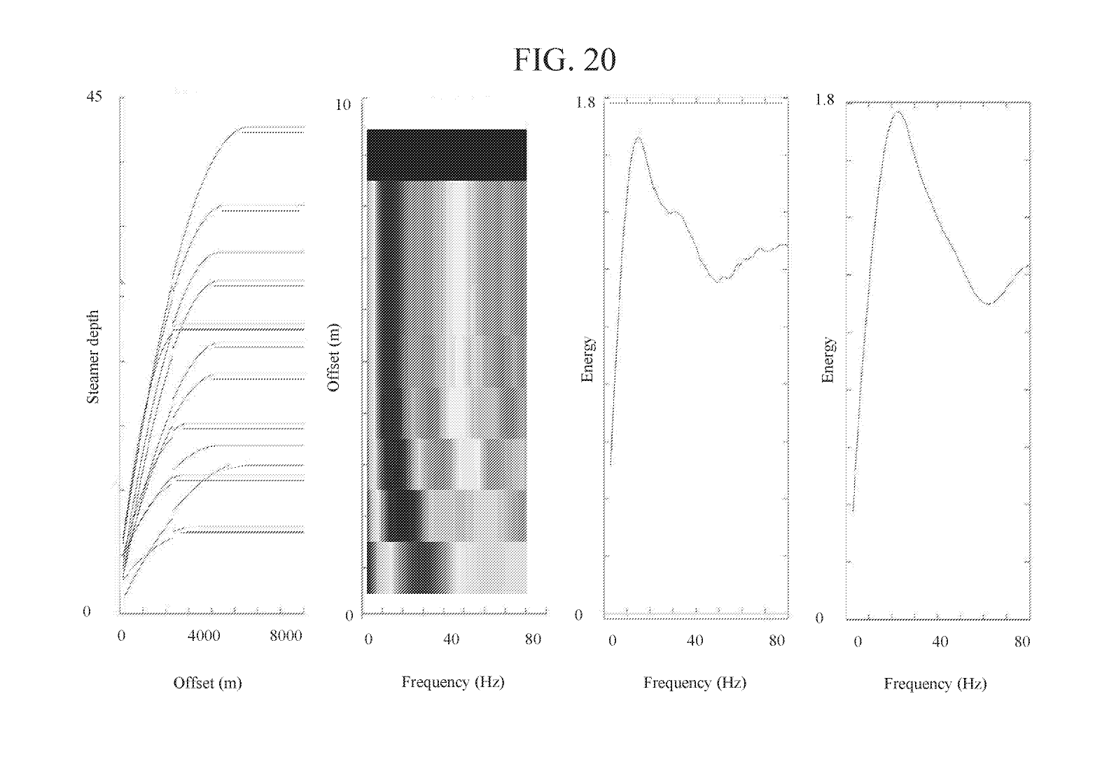

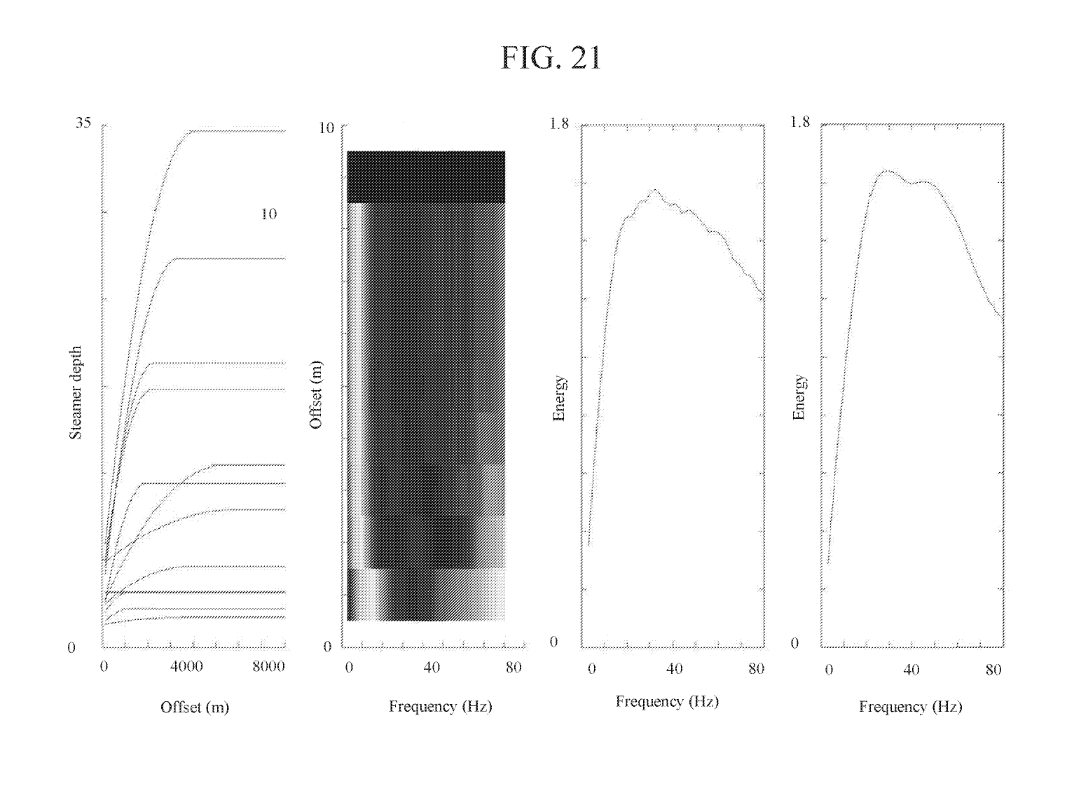

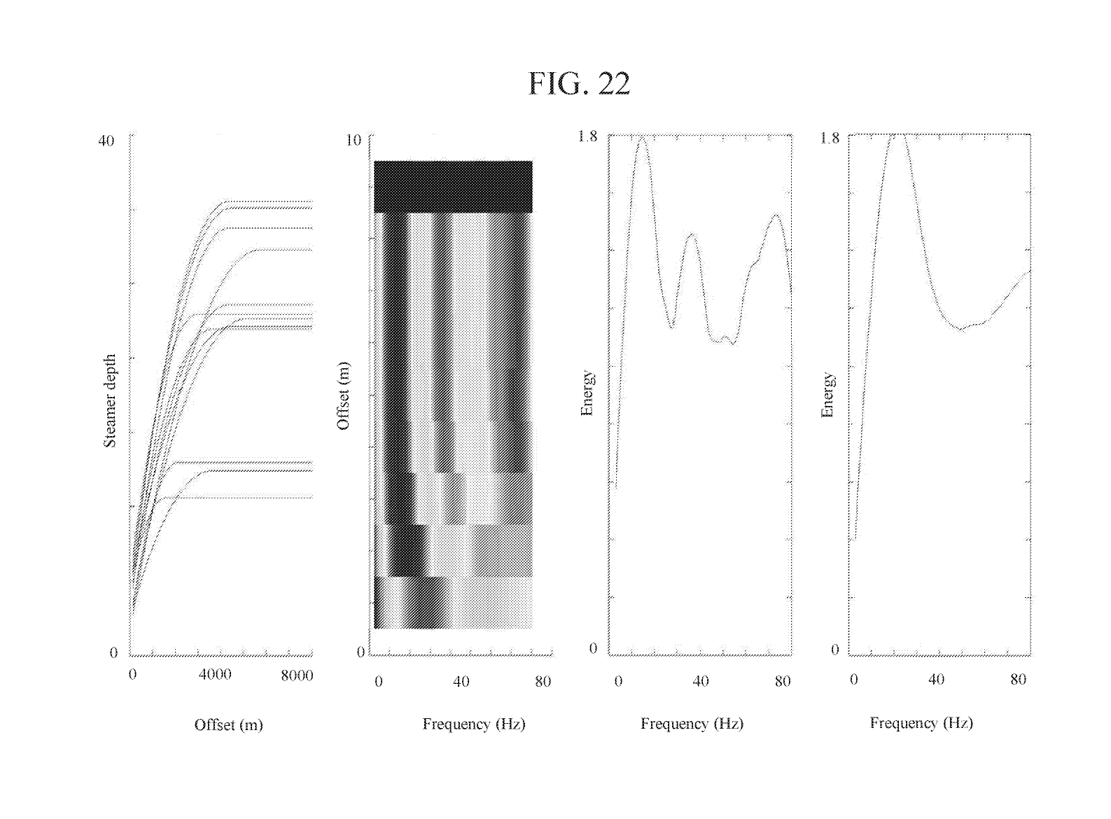

FIG. 17 shows the set of graphs for horizontal streamers at 8 m depth. FIG. 18 shows the set of graphs for variable depth streamers at 8-50 m depth. FIG. 19 shows variable depth streamers optimized for achieving a maximum average amplitude. FIG. 20 shows variable depth streamers optimized for achieving a maximum average octave amplitude. FIG. 21 shows variable depth streamers optimized for spectral flatness. Octaves are specific types of frequency ranges (e.g., related to doubling the frequencies, such as, 2-4 Hz, 4-8 Hz, 8-16 Hz, 16-32 Hz, 32-64 Hz, etc.). The amplitudes in each octave was first averaged. FIG. 22 shows variable depth streamers optimized for a combination of octave and spectral flatness.

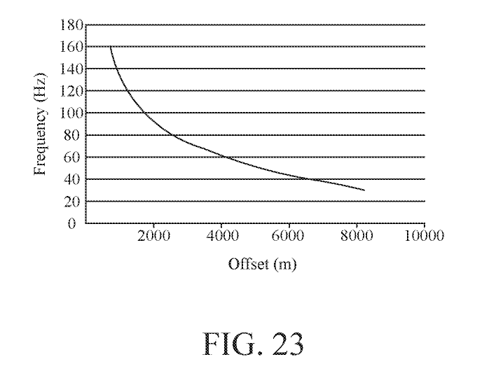

The optimization may be tuned to achieve different bandwidths at different offsets. For example, it may be prioritized to preserve high frequencies for the short offsets (since high frequencies are unlikely to stack in at long offsets), and/or to decrease maximum frequency for mid and long offset. FIG. 23 illustrates maximum desired frequency (Hz) as a function of offset (x). The optimization objectives may depend on the survey area and the targeted resolution for the result.

Besides optimizing the depths, the order of the streamers with different depths may be optimized. The order from left to right of the spread axis does not have to be an increasing/decreasing depth order. An optimal order may be derived based on synthetic modelling and 3D deghosting.

Instead of minimizing the impact of the receiver ghost based on the vertical propagation of incoming energy, the time shifts may be estimated based on ray tracing or simple 1D modelling. In the case of simple 1D modelling, the receiver ghost delay Δt may be calculated as:

$$Δ t = {t}_{u} - {t}_{d} = \frac{1}{v} ( \sqrt{{h}^{2} + {( 2 z - d )}^{2}} - \sqrt{{h}^{2} + {( 2 z + d )}^{2}} ) \qquad ( 12 )$$

where h is the source receiver offset, v is the wave propagation velocity, z is the reflector depth and d is the receiver's depth.

Instead of removing the ghost in pre-processing, the data (including ghost) may be processed through demultiple and migrated. The ghost attenuation may be included as part of the migration (including least squares migration), or may be removed post migration (e.g. using joint deconvolution).

Thus, an embodiment of a data acquisition system may be designed to include the following features:
1. acquiring data with streamer having more than one streamer profile, the spread being optimized for receiver ghost diversity, and
2. reconstructing multi-streamer wavefield based on data acquired with such a spread of streamers.

The wavefield reconstruction may include wavefield separation (up/down separation, deghosting) and/or spatial reconstruction (inline, crossline and/or in depth).

Instead of relating streamer profiles to a single acquisition, the data can be a result of plural acquisitions using different streamer profiles. For example, a survey area surveyed a first time using horizontal streamers may be surveyed a second time using BroadSeis streamers. The data acquired during the two surveys may be combined during processing. The data may have been acquired along the same acquisition direction or along different acquisition directions. The source positions may have been repeated or not.

The embodiments described in this document are relevant for any type of marine sources, and different types or receivers or combinations. If hydrophones and particle motion sensors are used simultaneously, receiver notch diversity may be optimized only up to a certain frequency below which the particle motion sensors may be too noisy to use.

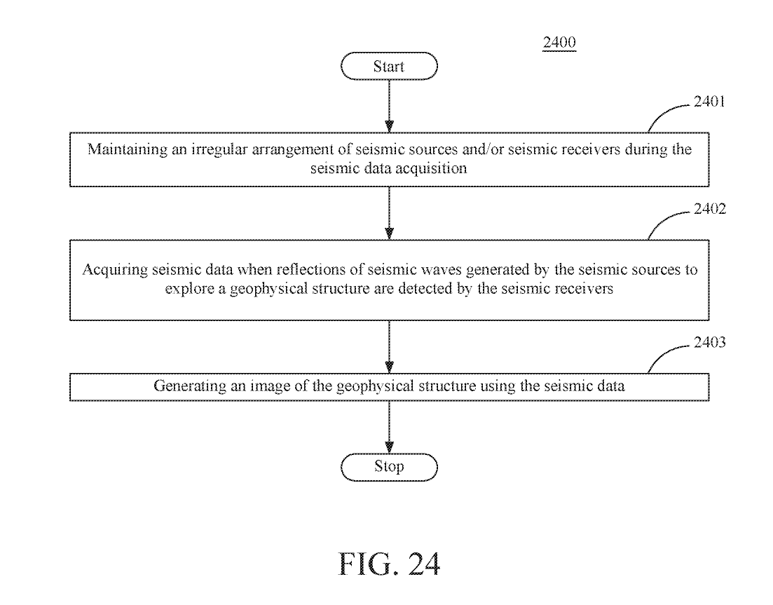

FIG. 24 is a flowchart of a method 2400 for diversifying source-receiver parameters during seismic data acquisition, according to an embodiment. At 2401, method 2400 includes maintaining an irregular arrangement of seismic sources and/or seismic receivers during the seismic data acquisition. The seismic sources and/or seismic receivers are seismic devices that determine the source-receiver parameters (i.e., offset, azimuth, etc.). The irregular arrangement departs in a predetermined manner from repetitive spatial patterns formed by or within groups of adjacent seismic sources or adjacent seismic receivers.

Method 2400 further includes acquiring seismic data when reflections of seismic waves generated by the seismic sources to explore a geophysical structure are detected by the seismic receivers at 2402. Method 2400 also includes generating an image of the geophysical structure using the seismic data at 2403.

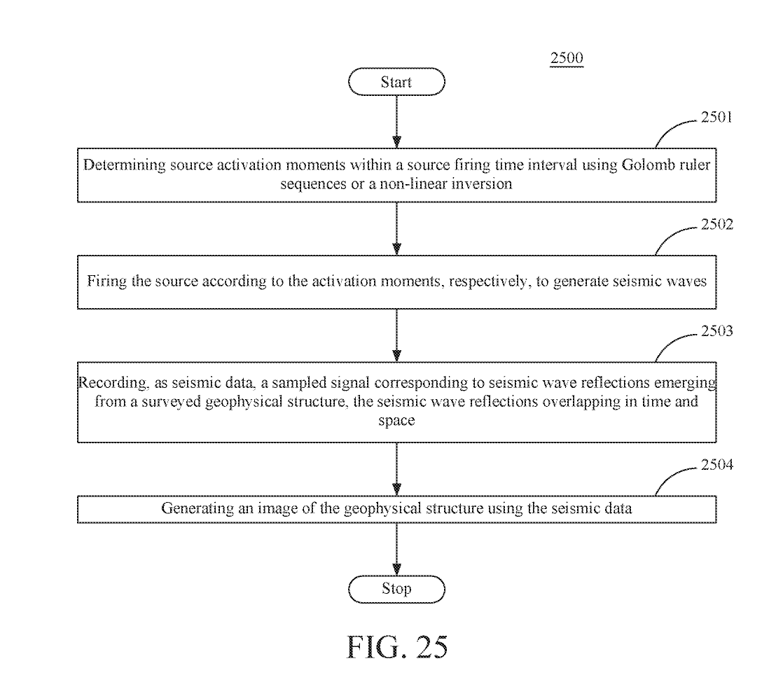

FIG. 25 is a flowchart of a method 2500 for diversifying source-receiver parameters during seismic data acquisition, according to another embodiment. Method 2500 includes determining source activation moments within a source firing time interval using Golomb ruler sequences or a non-linear inversion, at 2501. The method further includes firing the sources according to the activation moments, respectively, to generate seismic waves at 2502.

Method 2500 also includes recording, as seismic data, a sampled signal corresponding to seismic wave reflections emerging from a surveyed geophysical structure, at 2503. The seismic wave reflections overlap in time and space. Method 2500 then includes generating an image of the geophysical structure using seismic data, at 2504.

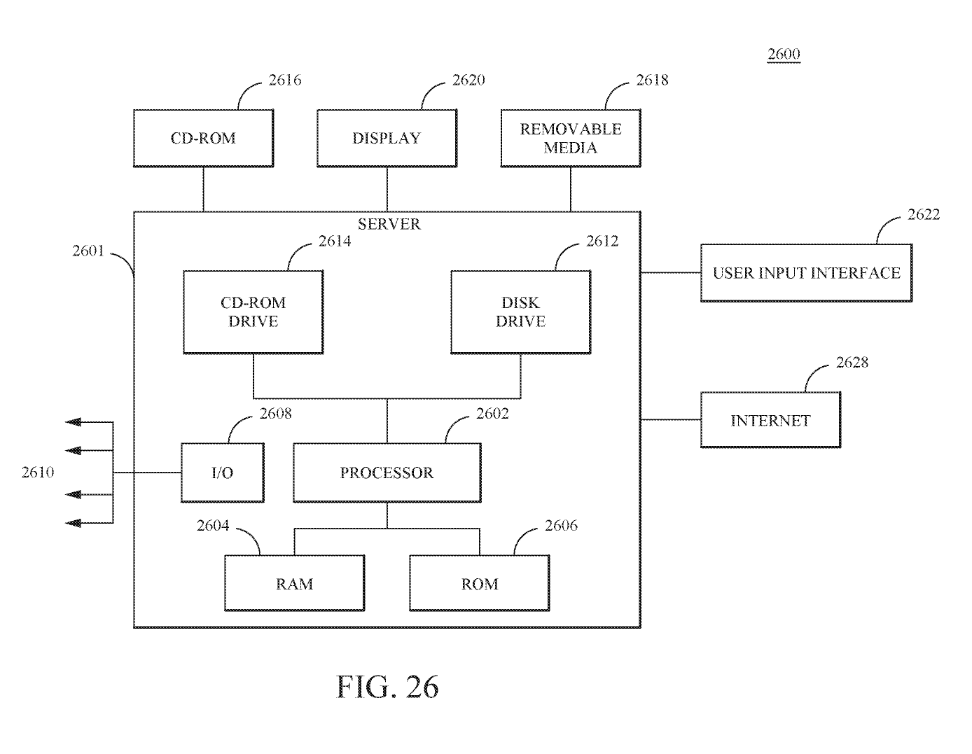

FIG. 26 illustrates a block diagram of a data processing apparatus 2600 according to an embodiment. Apparatus 2600 is programmed to calculate spatial intervals for the predetermined manner of departing from repetitive spatial patterns, by performing an inversion focused on a predetermined objective. Alternatively or additionally, apparatus 2600 is programmed to determine source activation moments within a source firing time interval using Golomb ruler sequences or a non-linear inversion.

Hardware, firmware, software or a combination thereof may be used to perform the various steps and operations. Processing device 2600 may include server 2601 having a central processor unit (CPU) 2602 having one or more processors. CPU 2602 is coupled to a random access memory (RAM) 2604 and to a read-only memory (ROM) 2606. ROM 2606 may also be other types of storage media to store programs, such as programmable ROM (PROM), erasable PROM (EPROM), etc. Methods according to various embodiments described in this section may be implemented as computer programs (i.e., executable codes) non-transitorily stored on RAM 2604 or ROM 2606. CPU 2602 may communicate with other internal and external components through input/output (I/O) circuitry 2608 and bussing 2610.

Server 2601 may also include one or more data storage devices, including disk drive 2612, CD-ROM drive 2614, and other hardware capable of reading and/or storing information (e.g., seismic data before and after processing), such as a DVD, etc. In one embodiment, software for carrying out the above-discussed steps may be stored and distributed on a CD-ROM 2616, removable media 2618 or other form of media capable of storing information. The storage media may be inserted into, and read by, devices such as the CD-ROM drive 2614, disk drive 2612, etc. Server 2601 may be coupled to a display 2620, which may be any type of known display or presentation screen, such as LCD, plasma display, cathode ray tube (CRT), etc. Server 2601 may control display 2620 to exhibit images generated using seismic data such as FIGS. 2-9. A user input interface 2622 is provided, including one or more user interface mechanisms such as a mouse, keyboard, microphone, touchpad, touch screen, voice-recognition system, etc.

Server 2601 may be coupled to other computing devices, such as the equipment of a vessel, via a network. The server may be part of a larger network configuration as in a global area network (GAN) such as the Internet 2628, which allows ultimate connection to various landline and/or mobile devices.

The disclosed exemplary embodiments provide seismic data acquisition systems departing from regular patterns in space and time. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A method for diversifying source-receiver parameters in seismic data acquisition, the method comprising:
maintaining an irregular arrangement of seismic devices that determine the source-receiver parameters during the seismic data acquisition, the irregular arrangement departing in a predetermined manner from repetitive spatial patterns formed by or within groups of adjacent among the seismic devices;
acquiring seismic data; and
generating an image of a geophysical structure using the seismic data.

2. The method of claim 1, wherein the predetermined manner of departing from repetitive spatial patterns includes using Golomb ruler sequences to calculate spatial intervals.

3. The method of claim 1, wherein the predetermined manner of departing from repetitive spatial patterns includes performing an inversion focused on a predetermined objective to calculate spatial intervals.

4. The method of claim 3, wherein the predetermined objective includes flattening a spectrum of the acquired seismic data and/or maximizing an average amplitude of the spectrum for a given frequency range.

5. The method of claim 3, wherein the predetermined objective includes at least two different objectives for different portions of the arrangement.

6. The method of claim 1, further comprising:
determining the irregular arrangement using a cost function incorporating optimization objectives and system constraints.

7. The method of claim 1, wherein the maintaining includes
using a streamer spread including at least two streamers having different depth profiles.

8. The method of claim 1, wherein the seismic devices include seismic receivers, and the method further comprises:
determining coordinates of the seismic receivers in a horizontal plane perpendicular to gravity based on aliasing or Fresnel zone, or to attenuate waves arriving to the seismic receivers from a predetermined direction,
wherein the irregular arrangement includes the seismic receivers being arranged according to the determined seismic receiver coordinates.

9. The method of claim 1, wherein the irregular arrangement includes streamers being towed by a same vessel and having different cross-line intervals, each of the streamers carrying a subset of seismic receivers, which are among the seismic devices.

10. The method of claim 1, wherein the irregular arrangement includes placing a subset of seismic receivers, which are among the seismic devices, at different intervals along a streamer.

11. (canceled)

12. The method of claim 1, further comprising extracting individual recordings related to each source firing from the seismic data, and attenuating energy other than energy related to a target source from each of the individual recordings.

13. A data acquisition system, comprising:
sources configured to generate seismic waves able to penetrate a surveyed geophysical structure inside which the seismic waves propagate with different speeds;
seismic receivers configured to detect reflections of the seismic waves emerging from the surveyed geophysical structure,
wherein
the seismic sources and the seismic receivers are deployed according to an irregular arrangement departing in a predetermined manner from repetitive spatial patterns formed by or within groups of adjacent among the seismic sources or adjacent among the seismic receivers, and
the seismic receivers record seismic data generated based on the detected reflections, and usable to generate images of the surveyed geophysical structure.

14. The data acquisition system of claim 13, further comprising:
a computer programmed to calculate spatial intervals for the predetermined manner of departing from repetitive spatial patterns, using Golomb ruler sequences.

15. The data acquisition system of claim 13, further comprising:
a computer programmed to calculate spatial intervals for the predetermined manner of departing from repetitive spatial patterns, by performing an inversion focused on a predetermined objective.

16. The data acquisition system of claim 13, wherein subsets of the receivers are disposed along streamers configured to be towed by a same vessel while having different depth profiles.

17. The data acquisition system of claim 13, wherein subsets of the receivers are disposed along streamers configured to be towed by a same vessel and to have different cross-line distances among at least two of the streamers.

18. The data acquisition system of claim 13, wherein a subset of receivers is disposed along a streamer such that to have different distances there-between.

19. The data acquisition system of claim 13, further comprising:
a computer programmed to determine source activation moments within a source firing time interval using Golomb ruler sequences or a non-linear inversion.

20. A computer readable medium (2601) non-transitorily storing executable codes which make a computer to execute a method for diversifying source-receiver parameters during seismic data acquisition, the method comprising:
determining spatial intervals for an irregular arrangement of seismic devices that determine the source-receiver parameters during a seismic data acquisition, the irregular arrangement departing in a predetermined manner from repetitive spatial patterns formed by or within groups of adjacent among the seismic devices; and/or
determining source activation moments within a series of source firing time intervals,
wherein the spatial intervals and/or the source activation moments are determined using Golomb ruler sequences or a non-linear inversion.
